(19) United States
(12) Patent Application Publication
(10) Pub. No.: US 2017/0178265 A1
(43) Pub. Date: Jun. 22, 2017

(54) METHOD AND SERVER FOR PROVIDING ONLINE COLLABORATIVE LEARNING USING SOCIAL NETWORK SERVICE

(71) Applicant: KOREA UNIVERSITY RESEARCH AND BUSINESS FOUNDATION, Seoul (KR)

(72) Inventors: Een Jun HWANG, Seoul (KR); Yong Sung KIM, Seoul (KR)

(21) Appl. No.: 15/381,054

(22) Filed: Dec. 15, 2016

(30) Foreign Application Priority Data
Dec. 17, 2015 (KR) 10-2015-0181209

(51) Int. Cl. G06Q 50/20; G06Q 10/10; G09B 5/12; G06Q 50/00

(52) U.S. Cl. CPC G06Q 50/2053; G06Q 50/01; G06Q 10/10; G09B 5/12

(57) ABSTRACT

A method and a server for providing online collaborative learning using a social network service are disclosed. The server for providing online collaborative learning comprises a category classification unit configured to classify learning information collected from a social network service SNS according to a category and store the collected learning information, a news extracting unit configured to extract learning information corresponding to query received from a learner terminal from the stored learning information and perform scoring about the extracted learning information according to preset reference, and a treemapping unit configured to determine a size of a specific shape in which the extracted learning information is visualized and provide the learning information visualized in the specific shape having the determined size to the learner terminal, the size being in proportion to a score corresponding to the scoring.

### PRIORITY

This application claims priority under 35 U.S.C. §119(a) to a Korean patent application filed on Dec. 17, 2015 in the Korean Intellectual Property Office and assigned Serial No. 10-2015-0181209, the entire disclosure of which is incorporated herein by reference.

### TECHNICAL FIELD

The present disclosure relates to a technique for providing online collaborative learning using a social network service.

### BACKGROUND ART

Newspaper in education (hereinafter, referred to as “NIE”) indicates an education method using a newspaper as a tool for class, was developed for the first time in USA in 1930, and has been continuously used for class in various subjects.

The NIE is generally progressed as follows:

A teacher determines a topic related to content to be learned, collects newspapers related to the determined topic, and provides information concerning the collected newspapers to learners.

The learners read newspaper articles related to the topic, and announce and describe their thought. The learners exchange diverse opinions in a group, and newly produce their newspapers.

Afterward, the teacher evaluates academic achievement based on output of the learner.

If the NIE is used in the class, it is useful for enhancing ability of critical thinking and solving literacy ability of the learners. Additionally, creativity and problem-solving ability are enhanced through various data related to the subject to be learned. That is, diverse advantages exist.

Accordingly, the NIE has been increasingly used in the class.

Recently, the newspaper is rapidly replaced with online newspaper according as digital devices have sharply developed.

News published on the online newspaper has been rapidly propagated in real time through new social network service such as a twitter.

However, the conventional NIE teaching method has one-way feature focused on the teacher. Furthermore, a used device is limited as a device determined by the teacher.

Moreover, news which does not reflect recent trend is used, and many the public's opinions cannot be verified.

### SUMMARY

Accordingly, the present invention is provided to substantially obviate one or more problems due to limitations and disadvantages of the related art.

One embodiment of the invention provides a method of classifying learning information collected from a social network service SNS according to a category and providing optimal learning information desired by a learner considering recent trend and popularity of the public.

Additionally, the invention provides a method of grouping learners whose learning propensity is similar, so as to perform online collaborative learning.

In one aspect, the present invention provides a server for providing online collaborative learning comprising: a category classification unit configured to classify learning information collected from a social network service SNS according to a category and store the collected learning information; a news extracting unit configured to extract learning information corresponding to query received from a learner terminal from the stored learning information and perform scoring about the extracted learning information according to preset reference; and a treemapping unit configured to determine a size of a specific shape in which the extracted learning information is visualized and provide the learning information visualized in the specific shape having the determined size to the learner terminal, the size being in proportion to a score corresponding to the scoring. Here, the news extracting unit gives the score by reflecting the preset reference including at least one of date of the learning information posted to the SNS, a number of recommendation of the learning information in the SNS or a number of delivery of the learning information to other users in the SNS, and extracts a certain number of learning information in an order of high score.

In another aspect, a method of providing online collaborative learning by a server, the method comprising: (a) classifying learning information collected from a social network service SNS according to a category and storing the collected learning information; (b) extracting learning information corresponding to query received from a learner terminal from the stored learning information and performing scoring about the extracted learning information according to a preset reference; and (c) determining a size of a specific shape in which the extracted learning information is visualized and providing the learning information visualized in the specific shape having the determined size to the learner terminal, the size being in proportion to a score corresponding to the scoring. Here, the step of (b) includes giving the score by reflecting the preset reference including at least one of date of the learning information posted to the SNS, a number of recommendation of the learning information in the SNS or a number of delivery of the learning information to other users in the SNS, and extracting a certain number of learning information in an order of high score.

The invention may classify efficiently much amount of learning information (for example, news, etc.) generated in a social network service SNS such as a twitter and provide optimal news to a learner considering an order reflecting recent trend and popularity of the public.

The learning information is provided to the learner by using various visualization methods, and thus the learner can easily recognize in advance content of the learning information even though he does not read full text of the learning information. Accordingly, a learning time may be saved, and the learner can easily figure out the point of the learning information.

The invention achieves online collaborative learning by using the SNS and a documentation tool based on a cloud, and so the learner may easily perform the learning at anytime and anywhere.

A teacher may reduce a time and effort for selection and reconfiguration of relative news, and the learner may perform a self directed learning.

Effect of the invention is not to effect mentioned above, and may include every effect capable of being inferred from description or claims of the invention.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a system for providing online collaborative learning using a social network service according to one embodiment of the invention;

FIG. 2 is a block diagram illustrating a service server according to one embodiment of the invention;

FIG. 3 is a flowchart illustrating a process of providing online collaborative learning using an SNS according to one embodiment of the invention; and

FIG. 4 is a flowchart illustrating a process of providing online collaborative learning using an SNS according to another embodiment of the invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

A section not related to description is omitted in drawings so as to describe distinctively the invention. Additionally, similar numerical number is applied to elements for performing similar function.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that the terms “comprises”, “comprising,”, “includes” and/or “including”, when used herein, specify the presence of stated features, integers, steps, operations, elements, and/or configurations, but do not preclude the presence or addition of one or more other features, integers, steps, operations, elements, configurations, and/or groups thereof.

Hereinafter, various embodiments of the invention will be described in detail with reference to accompanying drawings.

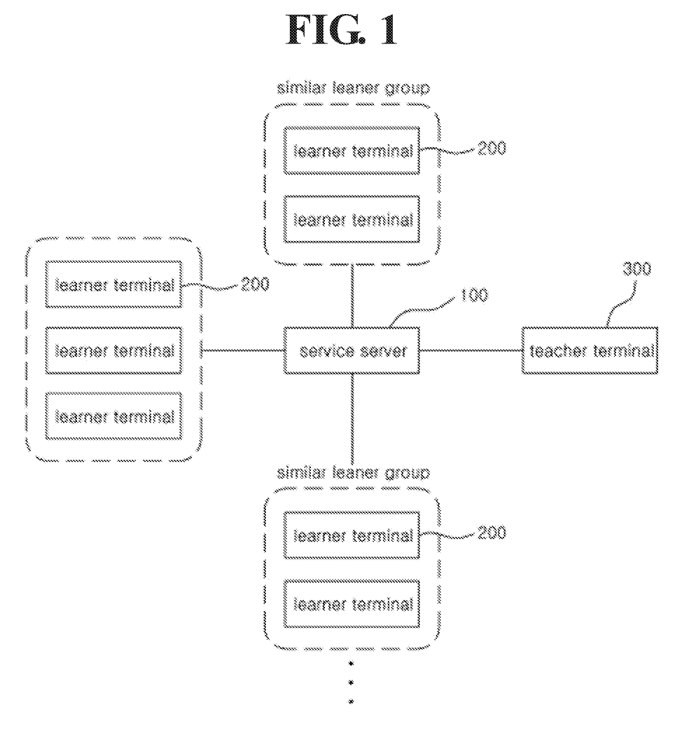

FIG. 1 is a view illustrating a system for providing online collaborative learning using a social network service according to one embodiment of the invention.

The system for providing the online collaborative learning using the social network service SNS according to the present embodiment may include a service server 100, a learner terminal 200 and a teacher terminal 300.

The service server 100 may efficiently classify much amount of learning information generated in the SNS, calculate an order reflecting recent trend and popularity of the public, and provide optimal learning information desired by the learner to the learner terminal 200 depending on the calculated order.

Hereinafter, it is assumed that news generated in a twitter is the learning information generated in the SNS.

However, the SNS is not limited as the twitter, and the learning information is not limited as the news.

The service server 100 may provide at least one of summary information or a keyword of the news using diverse visualization methods so that the learner can easily recognize in advance content of the news though he does not read full text of the news.

Additionally, the service server 100 may provide an environment allowing online collaborative learning by using the twitter and a documentation tool based on a cloud, and so the learner may easily perform the learning at anytime and anywhere.

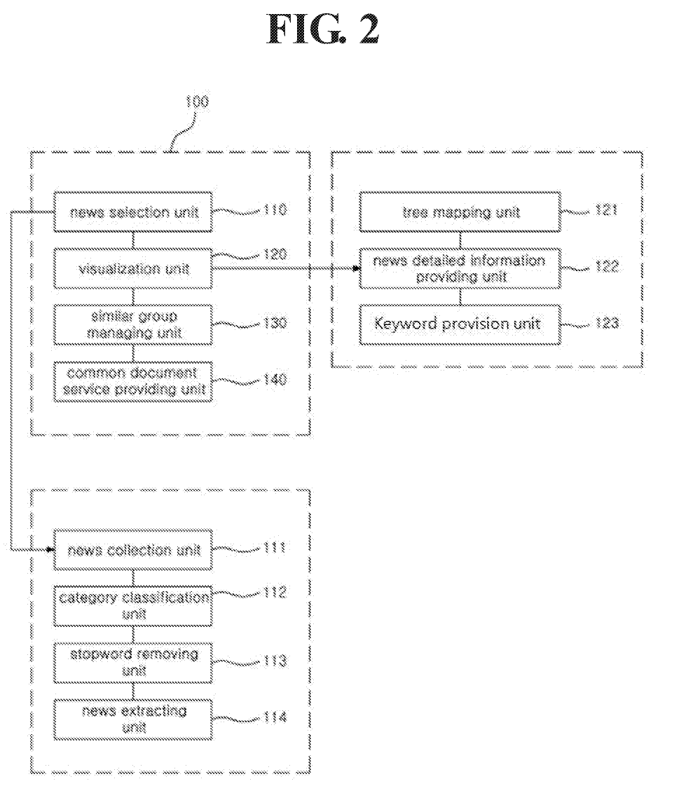

Detailed description concerning the service server 100 will be described with reference to accompanying drawing FIG. 2.

The learner terminal 200 may access the service server 100 and select desired news of news in the twitter provided from the service server 100.

Particularly, the learner terminal 200 may transmit query inputted by the learner to the service server 100, receive news matched with the query from the service server 100 and display the received news on its screen.

Here, the news displayed on the screen of the learner terminal 200 may be news reflecting the recent trend and the popularity of the public and be displayed in a specific shape (for example, circle or rectangular shape). Size of the shape may be in proportion to a score reflecting the recent trend and the popularity of the public.

Subsequently, when the learner selects specific news, the learner terminal 200 may receive one or more of the summary information or the keyword of the news from the service server 100 and display the received one or more on the screen.

Here, the keyword displayed on the screen of the learner terminal 200 may be thickly highlighted or be disposed at a position visible easily by the learner, and so the learner may easily recognize in advance content of the news.

The learner terminal 200 may store at least one news selected by the learner in a space (for example, a learning room of a learner account, etc.) provided by the service server 100.

Here, the news stored by the learner may be interest news which is interested by the learner or is favorite news of the learner. The service server 100 may use the interest news when it groups the learners into groups (hereinafter, referred to as “similar learner group) where learning propensity of learners is similar.

The learner terminal 200 may post a topic for discussion or opinion (comment, mension, etc.) inputted by corresponding learner in the twitter, so that the learner can communicate with the other learners in the similar learner group through the twitter.

The learner terminal 200 may perform a common essay working with other learners by using a common document service based on the cloud provided from the service server 100, and request it to service server 100 to transmit completed common working essay to the teacher terminal 300.

The teacher terminal 300 may display the learner's question through the twitter on the screen, and transmit answer about the question inputted by the teacher.

Furthermore, the teacher terminal 300 may access the service server 100, and search discussion topic of learners in corresponding group, working progression degree of the common working essay, etc. The teacher terminal 300 may evaluate participation degree of respective learners about the common essay working depending on working participation degree of respective learners provided from the service server 100.

The teacher terminal 300 may receive the common working essay submitted by respective similar learner groups from the service server 100.

On the other hand, the learner terminal 200 and the teacher terminal 300 may comprise every terminal connectable to the service server 100 through a network, for example comprise a mobile communication terminal including a smart phone, a portable phone, a personal digital assistant PDA, a portable multimedia player PMP, a table computer, etc., a laptop, a desktop computer, a television connected to a settop box and so on.

FIG. 2 is a block diagram illustrating a service server according to one embodiment of the invention.

The service server 100 of the present embodiment may include a news selection unit 110, a visualization unit 120, a similar group managing unit 130 and a common document service providing unit 140.

The news selection unit 110 may include a news collection unit 111, a category classification unit 112, a stopword removing unit 113 and a news extracting unit 114.

The news collection unit 111 may collect news so as to use in a newspaper in education (hereinafter, referred to as “NIE”).

Hereinafter, it is assumed that the news collection unit 111 collects twitter news to obtain efficiently trend news.

Of course, the news collected by the news collection unit 111 is not limited as only the twitter news.

Advantages when the twitter news is used for NIE are as follows:

First, trend and popularity of news generated in the past are easily recognized.

Particularly, the twitter may have a retweet function of delivering a tweet generated by other user to a follower of a user, and have a favorite function of storing the user's interested tweet and verifying the stored interested tweet later.

Both of the functions are displayed on a lower part of the tweet. The trend and the popularity may be easily recognized through the retweet function and the favorite function.

If the twitter news is used for the NIE, opinions of various users about the news may be easily detected.

A comment function exists in the twitter, and thus the users can post their opinions about corresponding tweet. Since the user may easily figure out some users' opinions through the comment, it is useful to perform the NIE class.

Writings of diverse topics as well as the news are posted in the twitter, and thus it is necessary to select only news tweet so as to use the news in the twitter.

In one embodiment, the news collection unit 111 may select top three twitter accounts from twitter accounts of newspapers in America based on a number of followers, select “Reuter news” account, which is a free account, from the selected top three twitter accounts, and collect news tweet.

The category classification unit 112 may classify the news tweets collected by the news collection unit 111 according to the category.

This is because the learners may easily search desired topics and easily remove a topic which is not effective in the NIE.

The category classification unit 112 may classify the news tweets according to the category by using a Naïve Bayes Classifier which is a supervised learning method.

If the news tweet is used as a training set for mechanical learning of the supervised learning method, the learning should be performed by using categorized data because the category is not designated.

The invention collects 2100 recent news (300 news per the category) from a homepage of the Reuter news account and uses the collected recent news as the training set.

To train this data set through a mechanical learning technique, the category classification unit 112 may extract a characteristic vector value by using a number of words included in an extracted message.

Since accuracy becomes lower if every extracted word is used as the characteristic vector value, the category classification unit 112 may remove low rank 20% words.

If the characteristic vector values are extracted, the category classification unit 112 performs the learning by using the extracted characteristic vector values through the Naïve Bayes Classifier.

The category classification unit 112 may classify data according to total seven categories including politics, economics, science/technology, international, entertainment, sports and health, and store the classified data in a database.

Of course, a kind of the categories is not limited as the above seven categories.

The stopword removing unit 113 may remove unnecessary word, letter, etc. so as to deliver most efficiently the news to the learner.

The news tweet include @ indicating an URL or a specific user, a RT meaning retweet and so on, and thus the stopword removing unit 113 should remove unnecessary word or letter, etc. so as to provide more simply and clearly the content to the learner.

The stopword removing unit 113 may remove unnecessary word, letter, etc. for the learner and keep only the content of the tweet by using a regular expression.

The stopword removing unit 113 may remove news tweets corresponding to the sports, the entertainment and the health which are not related directly to the learning and include contents difficult to be selected as discussion topic, so as to provide the content useful for learning.

In another embodiment, the news tweets corresponding to the sports, the entertainment and the health may not be removed.

The news extracting unit 114 may extract news desired by the learners and provide the extracted news to the learners.

The learners may input the query to search desired news. Here, the query may include at least one of a period of time during which the news is published, a keyword, news category desired by the learner or relative content.

The news extracting unit 114 may calculate score about the learner's input depending on following equation, and arrange the news in an order of high score.

Accordingly, popular news tweets which correspond to recent news may be automatically extracted, and the extracted news tweets may be provided to the learner. The learner may easily figure out contents issued by the public at present and recognize recent trend.

The news extracting unit 114 may extract news reflecting the recent trend and the popularity of the public based on following equation 1 to equation 5.

According to equation 1, current date and date on which news tweet is generated are compared, and recent news has higher score depending on the compared result.

$${r}_{ds} = 1 - \vert \frac{min ( {count}_{period} , {D}_{current} - {D}_{written}}{{count}_{period}} \vert \qquad [ Equation 1 ]$$

Here, count_{period} means desired period of time of the query inputted by the user.

For example, count_{period} equals to 3 if the user wants to verify data for three days.

Equation 2 is an equation for normalizing a result according to equation 1.

$${R}_{date} = \frac{{r}_{ds} - m ( {r}_{ds} , total )}{\frac{1}{N} {\sum }_{i = 1}^{N} {( {r}_{ds} - m ( {r}_{ds} , total ) )}^{2}} \qquad [ Equation 2 ]$$

Here, m(r_{ds},total) indicates an average of r_{ds} of every tweet in a specific category.

According to equation 3, higher score is obtained according as a number of the retweet increases.

$${R}_{rt} = \frac{cnt ( rt , tw ) - m ( rt , total )}{\frac{1}{N} {\sum }_{i = 1}^{N} {( cnt ( rt , tw ) - m ( rt , total ) )}^{2}} \qquad [ Equation 3 ]$$

Here, reference of Rₙ is different from that of R_{fv}, and thus a normalization is performed. cnt(rt, tw) means a number of retweet (rt) in one tweet (tw), and m(rt, total) indicates an average of a number of the retweet of every tweet in a specific category.

According to equation 4, higher score is obtained according as a number of writing designated as favorite writing increases in the tweet. Equation 4 is calculated like in equation 3.

$${R}_{fv} = \frac{cnt ( {f}_{v} , tw ) - m ( fv , total )}{\frac{1}{N} {\sum }_{i = 1}^{N} {( cnt ( fv , tw ) - m ( fv , total ) )}^{2}} \qquad [ Equation 4 ]$$

Equation 5 expresses summation of equation 2, equation 3 and equation 4. According to equation 5, tweet news is more recent news and has higher popularity according as the summation becomes greater.

scoreₜₒₜₐₗ=R_{date}+Rᵣₜ+R_{fv} [Equation 5]

The visualization unit 120 of the service server 100 may visualize efficiently the twitter news arranged in an order of high score for the purpose of online collaborative learning (news visualizer) and provide the visualized twitter news.

The visualization unit 120 may include a treemapping unit 121, a news detailed information providing unit 122 and a keyword provision unit 123.

The treemapping unit 121 may determine size of a specific shape in proportion to the score of the news extracted by the news extracting unit 114, and provide the news having the determined size of the specific shape to the learner terminal 200.

In one embodiment, news tweet having highest score may be shown in greatest size of a rectangular shape, and the size of the rectangular shape reduces according as the score gets lower.

Accordingly, the recent tweet news having high popularity is shown in the rectangular shape having the size higher than in other news, and thus the learners may easily verify recent news having high popularity.

The news detailed information providing unit 122 may provide detailed information concerning corresponding news to the learner terminal 200 when the learner clicks desired news of news displayed on the learner terminal 200.

In one embodiment, the news detailed information providing unit 122 may provide relative photograph, moving picture, comment, etc. connected to a URL of corresponding tweet in the twitter.

In another embodiment, the news detailed information providing unit 122 may provide real full text of the news connected to a URL address in the tweet.

The keyword provision unit 123 may provide one or more of summary or keyword of corresponding news to the learner terminal 200 when the learner clicks desired news of the news displayed on the learner terminal 200.

It is difficult for the learner to read the full text of every news. Accordingly, the keyword provision unit 123 may provide the summary and the keyword, etc. of the news, and the learner may figure out schematic topic and content before he reads every content of the news. As a result, the learner may determine in rapid time whether or not corresponding news is news needed for him.

The keyword provision unit 123 may extract the keyword of news selected by the learner based on following equation 6 to equation 8, and provide the extracted keyword.

tf (term frequency) in equation 6 expresses a frequency of a specific word shown in a document (news).

tf_{t,d}=log(1+f_{t,d}) [Equation 6]

idf (inverse document frequency) in equation 7 expresses a frequency of a specific word shown commonly in total document (news) groups.

$${idf}_{t , D} = log \frac{\vert N \vert}{\vert d ∈ D \text{:} t ∈ d \vert} \qquad [ Equation 7 ]$$

tf-idf in equation 8 expresses statistical numerical value which is an index showing importance of a specific word in news selected by the learner.

tf−idf_{t,d,D}=tf_{t,d}×idf_{t,D} [Equation 8]

The news includes very many words, and frequencies of the words shown in one news differ.

The keyword provision unit 123 may remove unimportant words such as an article or a verb from the words in the news so that the learner can easily verify important content.

The keyword provision unit 123 may extract every word from original news, remove the article or the verb from the extracted words through analysis of morpheme, and remove stopword which is not used or has low usage frequency in respective categories with reference to a stopword dictionary and so on.

Subsequently, the keyword provision unit 123 may verify important word in the news selected by the learner using equation 8.

That is, the keyword provision unit 123 may calculate importance of words in one news according to the category, select words selected in an order of high score as the keyword, and provide the words selected as the keyword.

In this time, the keyword provision unit 123 may use tag cloud based on the keyword, to view more efficiently the keyword.

Here, in the tag cloud, popular or important tags are thickly highlighted or are shown in a good position so that they are searched at a look, and their size is enlarged to have cloud shape.

Accordingly, the learners may verify the topic and the keyword of news document selected by them even though they do not read full text of every news, and they may easily recognize content of corresponding news.

The similar group managing unit 130 of the service server 100 may group learners whose learning propensity is similar in one group.

The discussion about the news is progressed and the essay is written by using the twitter when the NIE learning is performed. In this case, it is necessary to generate the group.

Excellent result may be obtained when the learners whose the learning propensity is similar belong to the same group.

The similar group managing unit 130 may analyze text of interest news stored in the learning room of the learner and generate a similar learner group according to the analyzed result.

The similar group managing unit 130 may generate the similar learner group by verifying similarity between texts of the news of respective learners and applying a clustering technique so that the similar learner group can be used for the NIE.

Particularly, the similar group managing unit 130 may detect similarity of interest news selected by the learners.

It is assumed that every news selected by the learner is one document. The similar group managing unit 130 may compare cosine similarity based on a value of every word in the document as shown in equation 9.

$$Similarity ( {v}_{i} , {v}_{j} ) = \frac{{v}_{i} \cdot {v}_{j}}{\vert {v}_{i} \vert \times \vert {v}_{j} \vert} \qquad [ Equation 9 ]$$

Here, vᵢ and vⱼ mean characteristic vector values showing frequencies of words in one document.

The similar group managing unit 130 may compare similarity of the learners, i.e. the similarity of the news selected by the learners based on a specific vector value, and group learners whose the similarity is more than predetermined reference value in the similar learner group.

Here, the similar learner group may be generated by using a hierarchical agglomerative clustering which is a similarity based clustering technique.

Accordingly, learners selecting similar news belong to the same similar learner group. The learners having similar learning propensity may perform collaborative learning, and thus efficiency of the learning may be enhanced.

A number of the similar learner groups may be approximately 3 to 5 according to class management state.

Learners in corresponding similar learner group discuss through the twitter in the event that the similar learner group is determined by the similar group managing unit 130.

Here, the twitter is used because students can generate easily a discussion space. The learners may use the twitter if they have question about a topic of the discussion or want to communicate one another.

If the learner wants to ask a question to the teacher, passive student may also ask easily a question and receive reply in real time, by using the twitter.

A hashtag function of the twitter may be used for separating the similar learner groups.

Here, the hashtag means indicating ‘#’ in front of a specific word, to express the keyword or the specific word.

In one embodiment, the hashtag may be used for separating selected words representing each of the similar learner groups.

That is, learners in corresponding similar learner group generate their hashtag and share the generated hashtag so that only they can access corresponding content.

Afterward, the learners read their favorite news and post news suitable for the discussion in the twitter.

In this time, each of the learners posts one news, and discusses reason selecting a specific news, issue, etc. through a comment and a mension function.

News including a topic discussed most actively and to be issued is finally selected, and a common essay working about the selected news may be performed by the similar learner group.

The common document service providing unit 140 may provide a common document working service based on a cloud so that common essay working can be performed by respective similar learner groups.

That is, any learner in the similar learner group can amend and make up for a document. The amended content of the document may be directly reflected, thereby enhancing efficiency.

The common document service providing unit 140 may provide a tracking function for tracking a learner amending the document, and measure working participation by counting a number of a word or a sentence made by the learners, a page, an image, a graph, a cited document, etc. when the common essay working is performed.

Here, the working participation may be used when the teacher evaluates the learners.

The essay may include various contents such as pro and con about news, reason selecting a specific news, provision of problem and its solution and so on.

The common document service providing unit 140 may transmit the common working essay to the teacher terminal 300 according to request of the learner terminal 200 in the similar learner group.

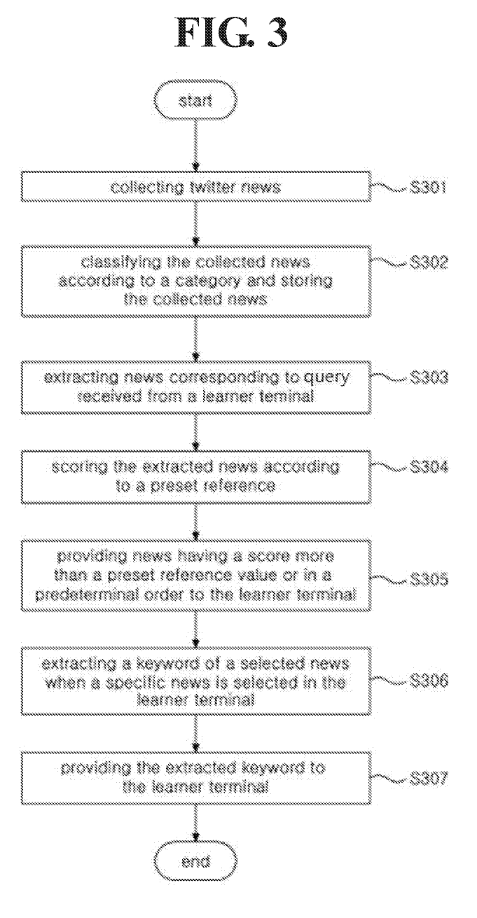

FIG. 3 is a flowchart illustrating a process of providing online collaborative learning using an SNS according to one embodiment of the invention.

Hereinafter, the flowchart in FIG. 3 is described based on an operation of the service server 100.

In a step of S301, the service server 100 collects twitter news.

In a step of S302, the service server 100 classifies the collected news according to a category and stores the collected news.

Here, the service server 100 may classify news tweet according to the category, by using Naïve Bayes Classifier which is a supervised learning method.

In a step of S303, the service server 100 extracts news corresponding to query received from the learner terminal 200.

Here, the query inputted by the learners may include one or more of period of time during which news is published, a keyword, news category desired by present himself or relative content.

In a step of S304, the service server 100 gives high score to recent news to by reflecting a preset reference, i.e. current date of the extracted news and generation date of the news tweet, gives higher score according as a number of retweet increases, gives higher score according as a number of favorite writing designated in the tweet increases, and summates the scores corresponding to the preset reference, the number of the retweet and the number of the favorite writing.

In a step of S305, the service server 100 extracts news, having a summation score in the step of S304 more than a preset reference value or in a predetermined order, from the extracted news in the step of S303, and provides the extracted news to the learner terminal 200.

Here, the news provided to the learner terminal 200 may be displayed on the learner terminal 200 in a shape having a size in proportion to the summation score in the step of S304.

In a step of S306, in the event that a specific news is selected from the learner terminal 200, the service server 100 calculates importance of a word considering a frequency of the word shown in the selected news and a frequency of the word shown commonly in total document groups, and extracts a keyword of the news selected by the learner according to the calculated importance.

In a step of S307, the service server 100 provides the extracted keyword to the learner terminal 200.

Here, the keyword of the news provided to the learner terminal 200 may be expressed in a tag cloud method.

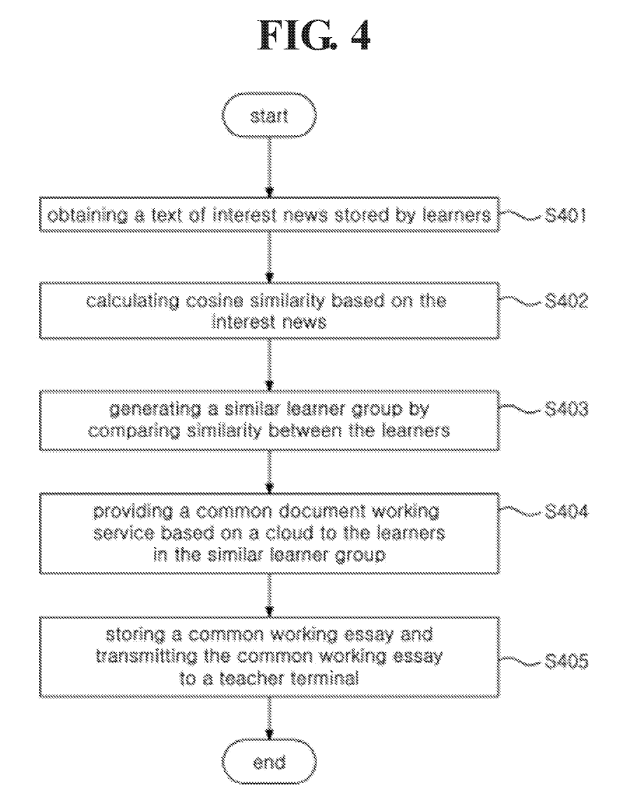

FIG. 4 is a flowchart illustrating a process of providing online collaborative learning using an SNS according to another embodiment of the invention.

FIG. 4 shows a process of grouping learners whose learning propensity is similar through the service server 100.

Hereinafter, the flowchart in FIG. 4 is described based on an operation of the service server 100.

In a step of S401, a service server 100 obtains a text of interest news stored in learning rooms of learner accounts.

In a step of S402, the service server 100 assumes every news selected by the learners as one document, and calculates cosine similarity depending on a value of every word in the document.

In a step of S403, the service server 100 compares similarity between news selected by the learners, and generates similar learner groups by grouping learners of which the similarity is more than a reference value.

In a step of S404, the service server 100 provides a common document working service based on a cloud to the learners in corresponding similar learner group.

Here, the learners in the similar learner group may discuss through the twitter, and generate a document through an essay common working based on the cloud.

In a step of S405, a common working essay generated by the similar learner group may be stored in the service server 100, and the service server 100 transmits the common working essay to a teacher terminal 300 according to request of the learner.

As described above, a twitter news usage education for the online collaborative learning according to one embodiment of the invention may efficiently many news generated in the twitter, and provide optimal news to the learners by calculating the order reflecting recent trend and popularity of the public.

The news is provided to the learner through diverse visualization methods, and thus the learner may easily recognize in advance the content of the news even though he does not read full text of the news. Accordingly, a time may be saved and the learner may easily figure out point of the news.

The online collaborative learning can be performed by using a documentation tool based on the SNS and the cloud, and thus the learning may be easily progressed at anytime and anywhere.

The teacher may reduce a time and effort for selection and reconfiguration of relative news, and the learner may progress a self directed learning.

Components in the embodiments described above can be easily understood from the perspective of processes. That is, each component can also be understood as an individual process. Likewise, processes in the embodiments described above can be easily understood from the perspective of components.

The embodiments of the invention described above are disclosed only for illustrative purposes.

For example, element in a body may be modified to separated elements, and separated elements may be realized with combined element.

A person having ordinary skill in the art would be able to make various modifications, alterations, and additions without departing from the spirit and scope of the invention, but it is to be appreciated that such modifications, alterations, and additions are encompassed by the scope of claims set forth below.

### DESCRIPTION OF REFERENCE NUMBERS

100: service server
110: news selection unit
111: news collection unit
112: category classification unit
113: stopword removing unit
114: news extracting unit
120: visualization unit
121: treemapping unit
122: news detailed information providing unit
123: keyword provision unit
130: similar group managing unit
140: common document service providing unit

1. A server for providing online collaborative learning, the server comprising:
a category classification unit configured to classify learning information collected from a social network service SNS according to a category and store the collected learning information;
a news extracting unit configured to extract learning information corresponding to query received from a learner terminal from the stored learning information and perform scoring about the extracted learning information according to preset reference; and
a treemapping unit configured to determine a size of a specific shape in which the extracted learning information is visualized and provide the learning information visualized in the specific shape having the determined size to the learner terminal, the size being in proportion to a score corresponding to the scoring,
wherein the news extracting unit gives the score by reflecting the preset reference including at least one of date of the learning information posted to the SNS, a number of recommendation of the learning information in the SNS or a number of delivery of the learning information to other users in the SNS, and extracts a certain number of learning information in an order of high score.

2. The server of claim 1, further comprising:
a group managing unit configure to compare similarity of interest learning information stored by learners in the event that the learning information provided to the learner terminal is stored as the interest learning information by corresponding learner, and group learners whose the similarity is more than a preset reference value in one group.

3. The server of claim 2, wherein the group managing unit assumes the stored interest learning information as one document, and compare the similarity between the learners depending on a characteristic vector value which indicates a frequency of a word shown in the one document.

4. The server of claim 2, further comprising:
a common document service providing unit configured to provide a common document working service based on a cloud, to perform a common document working in respective groups.

5. The server of claim 1, further comprising:
a news detailed information providing unit configured to provide at least one of an image, a moving picture or an article connected to a selected learning information, comment of users using the SNS, or detailed content or full text of the learning information, when the visualized learning information is selected by the learner terminal.

6. The server of claim 1, further comprising:
a keyword provision unit configured to generate at least one of a summary or a keyword of a selected learning information when the visualized learning information is selected by the learner terminal, and provide the generated at least one to the learner terminal.

7. The server of claim 6, wherein the keyword provision unit gives a score about words based on the frequencies of the words shown in the selected learning information and frequencies of the words shown commonly in every learning information stored as interest learning information by the learner, and providing a specific number of words selected in an order of high score as the keyword.

8. A method of providing online collaborative learning by a server, the method comprising:
(a) classifying learning information collected from a social network service SNS according to a category and storing the collected learning information;
(b) extracting learning information corresponding to query received from a learner terminal from the stored learning information and performing scoring about the extracted learning information according to a preset reference; and
(c) determining a size of a specific shape in which the extracted learning information is visualized and providing the learning information visualized in the specific shape having the determined size to the learner terminal, the size being in proportion to a score corresponding to the scoring,
wherein the step of (b) includes giving the score by reflecting the preset reference including at least one of date of the learning information posted to the SNS, a number of recommendation of the learning information in the SNS or a number of delivery of the learning information to other users in the SNS, and extracting a certain number of learning information in an order of high score.

9. The method of claim 8, further comprising:
comparing similarity of interest learning information stored by learners in the event that the learning information provided to the learner terminal is stored as the interest learning information by corresponding learner, and grouping learners whose the similarity is more than a preset reference value in one group.

10. The method of claim 8, further comprising:
providing a common document working service based on a cloud, to perform a common document working in respective groups.

11. The method of claim 8, further comprising:
providing at least one of an image, a moving picture or an article connected to a selected learning information, comment of users using the SNS, or detailed content or full text of the learning information, when the visualized learning information is selected by the learner terminal.

12. The method of claim 8, further comprising:
generating at least one of a summary or a keyword of a selected learning information when the visualized learning information is selected by the learner terminal, and providing the generated at least one to the learner terminal.
